(19) United States
(12) Patent Application Publication
(10) Pub. No.: US 2009/0116054 A1
(43) Pub. Date: May 7, 2009

(54) APPARATUS, METHOD AND PROGRAM FOR IMAGE FORMING

(75) Inventor: Toshiyuki Mitsudomi, Numazu-shi (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/934,906

(22) Filed: Nov. 5, 2007

(51) Int. Cl. G06F 15/00

(52) U.S. Cl. 358/1.15; 709/223; 358/1.14

(57) ABSTRACT

An image forming apparatus includes an image forming unit to form an image, a wireless LAN connection unit to connect to a network via wireless, a cause estimating unit to estimate a cause in a case where a connection to the network can not be established by the wireless LAN connection unit, and a display unit to display the estimated cause.

### BACKGROUND OF THE INVENTION

1. Field of the Invention

The present invention relates to an apparatus, a method and a program for image forming, in which a function to connect to a local area network (LAN) via a wireless system is installed.

2. Description of the Related Art

In recent years, a wireless LAN becomes widespread which is a LAN configured by connecting equipments using radio waves or light. For example, a wireless communication function is installed in a peripheral equipment such as a printer, and it is connected to a network of a user. By this, a large scale wiring work is avoided, and the network can be configured simply and inexpensively.

On the other hand, it is pointed out that the wireless LAN has demerits.

A first demerit is the instability of communication due to peripheral environments. The wireless LAN is much influenced by the peripheral environments from the properties thereof. Besides, when a peripheral equipment is placed in a place where radio waves hardly reach, the communication speed is reduced, or the communication can not be performed.

The second demerit is the necessity of security measures. Since a third party can wiretap information from a remote place, there is a fear that personal information leaks out. Thus, the security measures such as encryption of data and authentication must be sufficiently performed.

Accordingly, when a peripheral equipment is joined to a network, it is important that the peripheral equipment is placed at an appropriate place, and various settings including the setting of security for connection to the wireless LAN are performed.

The operational function of a setting unit provided in the peripheral equipment is insufficient as compared with a keyboard or the like provided in an information processing apparatus, and an input operation is complicated. Then, the peripheral equipment and a registration utility program of the peripheral equipment are made to cooperate with each other, and the network setting of the peripheral equipment is performed, so that the peripheral equipment is joined to a desired network by a method simpler than that of the related art. And then, it is displayed on a setting screen that the peripheral equipment is normally connected to the wireless network or is not connected (JP-A-2004-222001).

### BRIEF SUMMARY OF THE INVENTION

According to a first aspect of the invention, an image forming apparatus includes an image forming unit to form an image, a wireless LAN connection unit to connect to a network via wireless, a cause estimating unit to estimate a cause in a case where a connection to the network can not be established by the wireless LAN connection unit, and a display unit to display the estimated cause.

According to a second aspect of the invention, an image forming method of an image forming apparatus including an image forming unit to form an image and a wireless LAN connection unit to connect to a network via wireless, includes a cause estimating step of estimating a cause in a case where a connection to the network can not be established by the wireless LAN connection unit, and a display step of displaying the estimated cause.

According to a third aspect of the invention, an image forming program is executed by an image forming apparatus including an image forming unit to form an image and a wireless LAN connection unit to connect to a network via wireless, and the image forming program includes a cause estimating step of estimating a cause in a case where a connection to the network can not be established by the wireless LAN connection unit, and a display step of displaying the estimated cause.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a structure of a control system of an image forming apparatus of an embodiment.

FIG. 2 is a view showing a network structural example of a wireless LAN in an infrastructure mode.

FIG. 3 is a flow diagram showing a process procedure to determine a cause by which a connection to a wireless LAN can not be established.

FIG. 4 is a view showing a frame format delivered from an access point.

FIG. 5 is a view showing the display content of a control panel.

FIG. 6 is a view showing the detailed content of a cause by which the connection to the wireless LAN can not be established.

FIG. 7 is a view showing the detailed content of a cause by which the connection to the wireless LAN can not be established.

FIG. 8 is a view showing a network structural example of a wireless LAN in an ad-hoc mode.

### DETAILED DESCRIPTION OF THE INVENTION

Hereinafter, an embodiment of the invention will be described while using an image forming apparatus (MFP: Multi Function Peripheral) 201 as an example.

The image forming apparatus 201 is a digital compound machine which scans, reads and copies an image at a specified resolution and sheet size, and further, comprehensively utilizes functions of various office equipments, such as an image reception function of FAX, an image reception function of E-mail, and a print image reception function of a network.

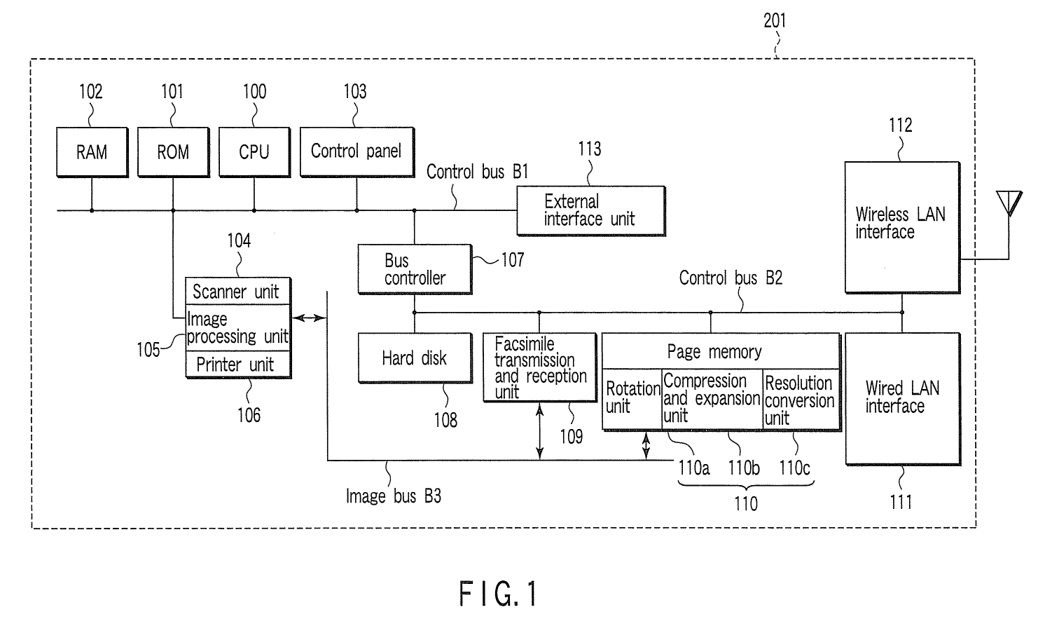

FIG. 1 is a block diagram showing a structure of a control system of the image forming apparatus 201 of the embodiment.

The image forming apparatus 201 includes a CPU 100, a ROM 101, a RAM 102, a control panel 103, a scanner unit 104, an image processing unit 105, a printer unit 106, a bus controller 107, and an external interface unit 113. The respective units are connected to each other through a control bus B1.

The CPU 100 overall controls the image forming apparatus 201. The ROM 101 stores various control programs necessary for the image forming apparatus 201 to operate. The RAM 102 is a buffer memory to temporarily store data generated from the execution of a control program. The control panel 103 is an instruction input unit configured to instruct the operation of the image forming apparatus 201 or to input a setting value for the operation of the image forming apparatus 201.

The scanner unit 104 reads image information as image data from an original document. The image processing unit 105 smoothes and removes noise which was mixed at the time of image reading, and sharpens an edge in which a blur occurs by the smoothing. Besides, a masking/trimming process, a scaling process and the like are also performed. Further, the read image data is gradation converted into a specified gradation number. The printer unit 106 outputs the gradation-converted image data as an image to a medium such as a sheet.

The bus controller 107 controls transferred signals among the respective units, which flow through the control bus B1. The external interface unit 113 is an interface to give and receive data to and from a detachable and attachable external apparatus (not shown) and to capture its operation state and the like.

Further, the bus controller 107 is connected to a hard disk 108, a facsimile transmission and reception unit 109, a page memory 110, a wired LAN interface 111 and a wireless LAN interface 112 through a control bus B2. The bus controller 107 controls transferred signals among the respective units, which flow through the control bus B2.

The hard disk 108 is a storage medium, such as a HDD, installed in the inside of the image forming apparatus 201. The facsimile transmission and reception unit 109 is an interface for performing facsimile communication with an external apparatus (not shown) through a public switched telephone network PSTN.

The page memory 110 is a memory to receive and store image data and to realize image formation by again transferring the stored image data. Further, the page memory 110 is provided with a rotation unit, a compression and expansion unit, and a resolution conversion unit. When the image data is outputted to the printer unit 106, the rotation unit 110a rotates the image data by 90 degrees or −90 degrees. The compression and expansion unit 110b compresses the image data in order to use it for facsimile transmission or optical disk storage, and expands the compressed image data in order to visualize it. The resolution conversion unit 110c converts the resolution in order to transmit and receive the image data to and from an equipment having a different resolution.

The wired LAN interface 111 and the wireless LAN interface 112 are signal interfaces connected to a LAN via wired or wireless to give and receive information.

Incidentally, the image processing unit 105, the printer unit 106, the facsimile transmission and reception unit 109, and the page memory 110 deliver and receive the image data through an image bus B3. Further, the hard disk 108, the facsimile transmission and reception unit 109, the page memory 110, the wired LAN interface 111, and the wireless LAN interface 112 can deliver and receive the image data through the control bus B2.

Besides, the scanner unit 104, the printer unit 106, and the facsimile transmission and reception unit 109 of the image forming apparatus 201 can operate independently.

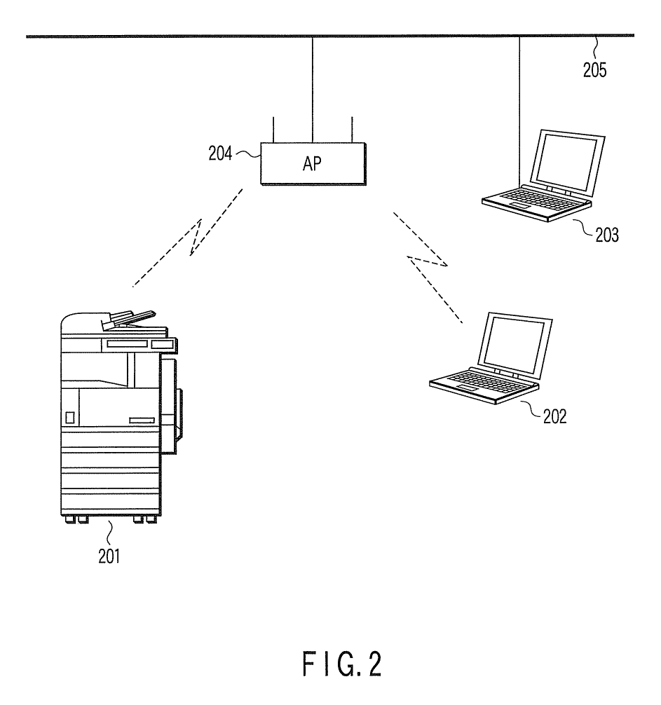

FIG. 2 is a view showing a network structural example of a wireless LAN in an infrastructure mode. In the infrastructure mode, an access point (AP) as a base station and wireless LAN terminals within the reach of radio waves are included. The access point is connected to a wired base network. The wireless LAN terminal establishes an association with one specific access point.

In FIG. 2, a client PC 203 and an access point 204 are connected to a wired network 205. Then, an image forming apparatus 201 and a client PC 202 are connected to the access point 204 via wireless and the wireless LAN is constituted.

In order that the image forming apparatus 201 is connected to the access point 204, it is necessary to perform settings of SSID (Service Set Identity) and the like to the wireless LAN interface 112. The SSID is one of network identifiers in the wireless LAN. It is necessary that the same SSID as that of the access point 204 to be connected is set in the image forming apparatus 201. That is, the access point 204 and the image forming apparatus 201 have the same SSID, so that a connection to an unintended network is prevented.

The access point 204 periodically delivers packet data called Beacon. Besides, as a response to packet data called Probe Request from the image forming apparatus or the like, packet data called Probe Response is returned. These packet data include the SSID of the access point 204. Accordingly, the image forming apparatus 201 which has detected the Beacon can know that the connectable access point 204 exists within the reach of radio waves, and can connect to the access point 204.

On the other hand, the security technique of the wireless LAN includes many things. There are many kinds of security standards such as, for example, an encryption technique by WEP (Wired Equivalent Privacy), an encryption technique by WPA (Wi-Fi Protected Access) in which the WEP is enforced, and WPA2 in which the WPA is further enforced. Besides, there is a case where an authentication system using a RADIUS server to manage a user ID and a pass word is used.

The security technique tends to become sophisticated and complicated year after year. Thus, the setting for connection to the wireless LAN also becomes complicated. Accordingly, there occur many cases where the connection to the wireless LAN can not be established since the setting of the security is not properly performed.

Besides, naturally, there is also a case where a connection can not be established since radio waves do not reach by such a cause that the distance from the access point as an connection object is long, or an obstruction exists therebetween.

As stated above, as the cause to prevent the connection to the wireless LAN, plural factors can be enumerated. Accordingly, in the case where the connection to the wireless LAN can not be established, it is not generally easy to specify the cause.

In the image forming apparatus 201 of the embodiment of the invention, in the case where the connection to the wireless LAN can not be established, the image forming apparatus itself has the function to estimate the cause and to notify it to the user. Specifically, it is determined which of following two causes is the cause by which the connection can not be established.

(1) The connection to the access point or the like can not be established since the security setting is not correct.

(2) The access point or the like to be connected can not be found (radio waves do not reach, the SSID is different, or the like).

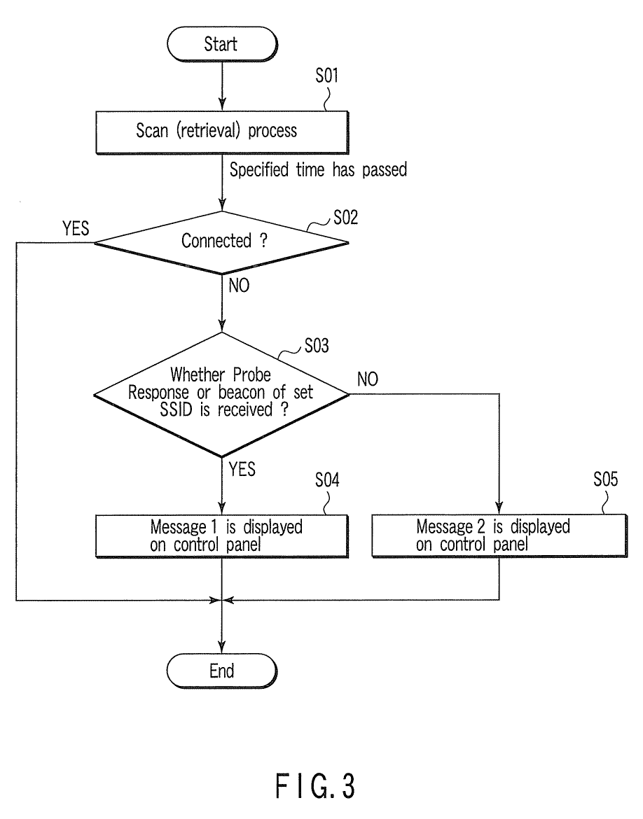

FIG. 3 is a flow diagram showing a process procedure to determine the cause by which the connection to the wireless LAN can not be established. A determination process program stored in, for example, the ROM 101 is started under the CPU 100 so that this process can be executed.

In the case where the power source of the image forming apparatus 201 is turned ON, or the user performs a specified operation from the control panel 103 and the connection to the wireless LAN is started, at step S01, the determination process program executes a scan process. In this scan process, a delivery signal from the access point existing in the vicinity of the image forming apparatus 201 is retrieved.

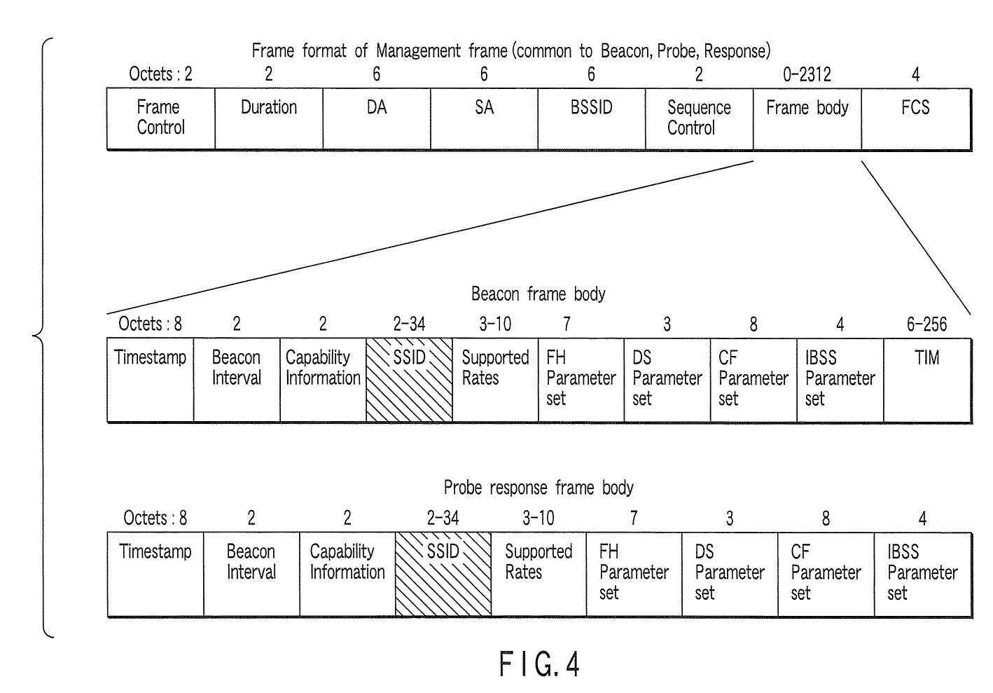

FIG. 4 is a view showing a frame format delivered from the access point.

The SSID is included in the Beacon frame or the Probe Response frame delivered from the access point.

When the Beacon frame or the Probe Response frame including the same SSID as the SSID set in the image forming apparatus 201 is received, the determination process program stores that effect into the RAM 102 and starts the connection.

Return is made to FIG. 3, and after a previously set time, such as, for example, 2 minutes, has passed since the start of the scan process, at step S02, the determination process program checks whether the image forming apparatus 201 is connected to the wireless LAN. In the case of Yes at step S02, that is, in the case where the connection to the wireless LAN is established, the determination process is ended. In the case of No at step S02, that is, in the case where the connection to the wireless LAN is not established, the reason why the connection can not be established is checked.

At step S03, the determination process program searches the RAM 102 and checks the scan process result.

In the case of Yes at step S03, that is, in the case where the Beacon frame or the Probe Response frame including the same SSID as the SSID set by the image forming apparatus 201 is received, the state is such that although a partner to which the connection is to be established is found, the connection can not be established. Since the radio waves of the partner to which the connection is to be established reach the image forming apparatus 201, it is necessary that the security setting of the image forming apparatus 201 is confirmed and corrected, so that the setting conforms to the access point to be connected. That is, it is determined that the connection to the wireless LAN can not be established because of the above (1). Accordingly, at step S04, a message 1 is displayed on the control panel 103.

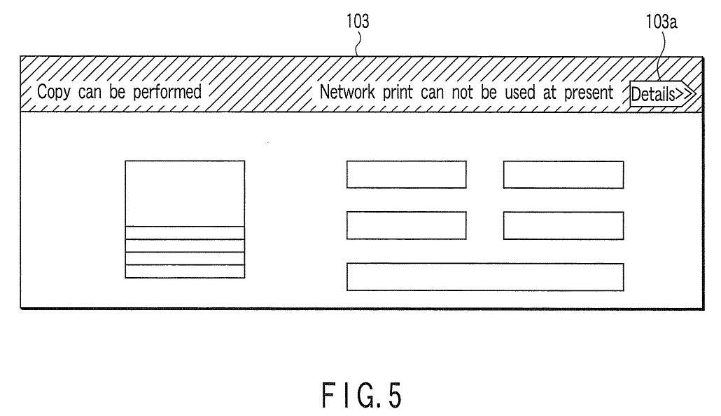

FIG. 5 is a view showing the display content of the control panel 103.

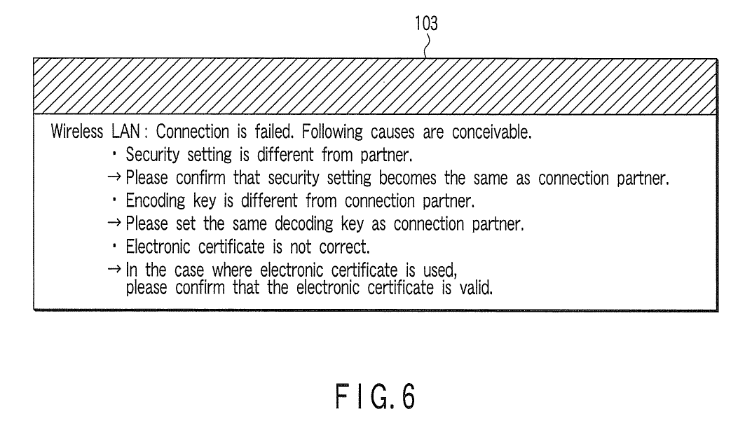

A detailed button 103a, together with the message indicating that the connection to the wireless LAN can not be established, is displayed on the control panel 103. When the user operates the detailed button 103a, the detailed contents of causes by which the connection to the wireless LAN shown in FIG. 6 can not be established are displayed.

The user confirms the displayed estimated causes, and can resolve the poor state by again performing the setting operation. Incidentally, for the convenience of the user, when the user specifies one of the estimated causes displayed on the control panel 103, a guidance indicating the operation procedure for the setting may be displayed. When a cancel button (not shown) provided on the control panel 103 is operated, return is made to the display shown in FIG. 5, and the determination process is ended. The user can specify a normal image forming operation after this.

In the case of No at step S03, that is, in the case where the Beacon frame or the Probe Response frame including the same SSID as the SSID set by the image forming apparatus 201 is not received, the state is such that the connection can not be established since a partner to which the connection is to be established is not found. In this case, first, it is confirmed whether the SSID is correctly set. In the case where the SSID is set correctly, it is necessary to perform such an adjustment that the distance between the connection partner such as the access point 204 and the image forming apparatus 201 is shortened, an obstacle therebetween is removed, or the output intensity of radio waves of the access point 204 is raised. That is, it is determined that the connection to the wireless LAN can not be established because of the above (2). Accordingly, at step S05, a message 2 is displayed on the control panel 103.

FIG. 5 is the view showing the display content of the control panel 103.

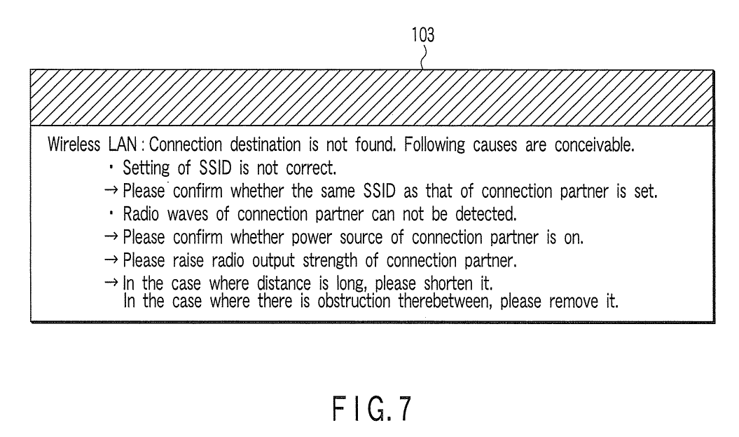

The detailed button 103a, together with the message indicating that the connection to the wireless LAN can not be established, is displayed on the control panel 103. When the user operates the detailed button 103a, the detailed contents of causes shown in FIG. 7 is displayed.

The user confirms the displayed estimated causes, and can resolve the poor state by again performing the setting operation. Incidentally, for the convenience of the user, when the user specifies one of the estimated causes displayed on the control panel 103, a guidance showing the operation procedure for the setting may be displayed. Besides, when the cancel button (not shown) provided on the control panel 103 is operated, return is made to the display shown in FIG. 5, and the determination process is ended. The user can specify the normal image forming operation after this.

In both the causes (1) and (2), the state is such that the image forming apparatus is not connected to the network. Thus, in the case where the image forming apparatus has the network print function or the network scanner function, a warning message is displayed to state clearly that the functions to use the network are in an unusable state.

As an example of the warning message, as shown in FIG. 5, in addition to “Network print can not be used at present”, for example, in the case of the image forming apparatus 201 having the function to transmit image data read by the scanner function to a specified PC via the network, a message of “Network scan can not be used at present. Only local storage can be performed.” is displayed.

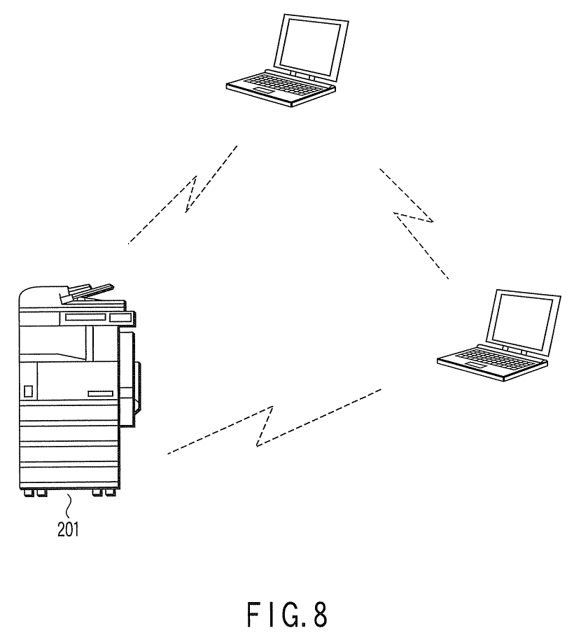

Incidentally, in the embodiment, although the image forming apparatus 201 is connected to the wireless LAN in the infrastructure mode, it may be connected to the wireless LAN in an ad-hoc (Ad-Hoc) mode shown in FIG. 8. The ad-hoc mode does not require an access point, but is constructed by only wireless LAN terminals. The wireless LAN terminals exchange wireless packets directly and perform communication.

In the ad-hoc mode, the image forming apparatus 201, instead of the access point, executes the setting operation of SSID or the like to the client PC. Accordingly, the process procedure can be similarly applied.

As described above, in the embodiment, in the case where the connection to the wireless LAN can not be established, the causes are roughly classified into two, i.e., a physical problem such as radio wave environments and a problem of security, and those are discriminated and displayed, and therefore, it becomes easy to identify the cause by which the connection can not be established.

Incidentally, the respective functions described in the embodiment may be constructed by using hardware, or may be realized by using software and by causing a computer to read a program describing the respective functions. Besides, the respective functions may be constructed by appropriately selecting the software and hardware.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus, comprising:
an image forming unit configured to form an image;
a wireless LAN connection unit configured to connect to a network via wireless;
a cause estimating unit configured to estimate a cause in a case where a connection to the network can not be established by the wireless LAN connection unit; and
a display unit configured to display the estimated cause.

2. The image forming apparatus according to claim 1, wherein
the cause estimating unit estimates which of (1) a connection partner can not be detected and (2) a connection is failed although the connection partner is detected is a cause by which the connection to the wireless LAN can not be established, and
the display unit displays a further detailed reason relating to the two estimated causes.

3. The image forming apparatus according to claim 2, further comprising a frame data reception unit configured to receive Beacon frame data or Probe Response frame data delivered from the network,
wherein from the received Beacon frame data or the Probe Response frame data, the cause estimating unit estimates which of the two causes is the cause by which the connection to the wireless LAN can not be established.

4. The image forming apparatus according to claim 2, wherein the display unit further comprises a resolving method display unit configured to display, together with the detailed reason, a method of resolving the reason.

5. The image forming apparatus according to claim 4, wherein the display unit further comprises a procedure display unit configured to display a guidance of a procedure for executing the method of resolving the reason.

6. An image forming method of an image forming apparatus including an image forming unit to form an image and a wireless LAN connection unit to connect to a network via wireless, comprising:
a cause estimating step of estimating a cause in a case where a connection to the network can not be established by the wireless LAN connection unit; and
a display step of displaying the estimated cause.

7. The image forming method according to claim 6, wherein
at the cause estimating step, it is estimated which of (1) a connection partner can not be detected and (2) a connection is failed although the connection partner is detected is a cause by which the connection to the wireless LAN can not be established, and
at the display step, a further detailed reason relating to the two estimated causes is displayed.

8. The image forming method according to claim 7, further comprising a frame data reception step of receiving Beacon frame data or Probe Response frame data delivered from the network,
wherein at the cause estimating step, it is estimated from the received Beacon frame data or the Probe Response frame data which of the two causes is the cause by which the connection to the wireless LAN can not be established.

9. The image forming method according to claim 7, wherein the display step further comprises a resolving method display step of displaying, together with the detailed reason, a method of resolving the reason.

10. The image forming method according to claim 9, wherein the display step further comprises a procedure display step of displaying a guidance of a procedure for executing the method of resolving the reason.

11. An image forming program executed by an image forming apparatus including an image forming unit to form an image and a wireless LAN connection unit to connect to a network via wireless, comprising:
a cause estimating step of estimating a cause in a case where a connection to the network can not be established by the wireless LAN connection unit; and
a display step of displaying the estimated cause.

12. The image forming program according to claim 11, wherein
at the cause estimating step, it is estimated which of (1) a connection partner can not be detected and (2) a connection is failed although the connection partner is detected is a cause by which the connection to the wireless LAN can not be established, and
at the display step, a further detailed reason relating to the two estimated causes is displayed.

13. The image forming program according to claim 12, further comprising a frame data reception step of receiving Beacon frame data or Probe Response frame data delivered from the network,
wherein at the cause estimating step, it is estimated from the received Beacon frame data or the Probe Response frame data which of the two causes is the cause by which the connection to the wireless LAN can not be established.

14. The image forming program according to claim 12, wherein the display step further comprises a resolving method display step of displaying, together with the detailed reason, a method of resolving the reason.

15. The image forming program according to claim 14, wherein the display step further comprises a procedure display step of displaying a guidance of a procedure for executing the method of resolving the reason.
